(19) United States
(12) Patent Application Publication
(10) Pub. No.: US 2026/0278454 A1
(43) Pub. Date: Sep. 17, 2026

(54) INTERACTIVE DECISIONING TOOL WITH ADAPTIVE GRAPHICAL USER INTERFACES

(71) Applicant: Truist Bank, Charlotte, NC (US)

(72) Inventors: Candi-Marie Chism, Statesville, NC (US); Patrick Ramp, Mooresville, NC (US)

(73) Assignee: Truist Bank, Charlotte, NC (US)

(21) Appl. No.: 19/078,619

(22) Filed: Mar. 13, 2025

(51) Int. Cl. G06N 20/00; G06F 3/0482; G06F 3/0483; G06F 3/0484

(52) U.S. Cl. CPC G06N 20/00; G06F 3/0482; G06F 3/0483; G06F 3/0484

(57) ABSTRACT

Systems, methods, and computer readable media for decisioning tools. A processor may access a configuration for a decisioning tool to determine a first prompt from multiple prompts. Based on this first prompt, a graphical user interface (GUI) for the decisioning tool may be generated by the processor. The processor receives a first input via the GUI, responding to the first prompt, and then determines a second prompt based on this input. The GUI is modified by the processor according to the second prompt, and a second input is received via the GUI in response to the second prompt. A decision may be returned by the processor, incorporating the inputs received through the GUI.

### BACKGROUND

Decisioning tools are software applications or platforms designed to aid in the decision-making process by analyzing data and providing actionable insights. Decisioning tools are used across various industries, including finance, healthcare, and logistics, to optimize performance, improve efficiency, and support strategic planning.

Creating responsive graphical user interfaces (GUIs) for decisioning tools is a challenging aspect of user experience design. One challenge is ensuring that the interface remains intuitive and dynamic, allowing users to effectively interact with the tool and receive real-time feedback as they input data or modify parameters. This requires a careful balance between aesthetic design, functionality, and performance.

### BRIEF SUMMARY

Embodiments of the present disclosure address the above needs and/or achieve other advantages by providing apparatuses, computer-readable media, and computer-implemented methods for an interactive decisioning tool with adaptive graphical user interfaces.

In various embodiments, a method includes a processor accessing the configuration of a decisioning tool. The processor determines a first prompt from multiple available prompts based on the configuration and generates a graphical user interface (GUI) for the decisioning tool according to the first prompt. The processor receives a first input via the GUI that responds to the first prompt. The processor then determines a second prompt based on the first input and modifies the GUI according to the second prompt. The processor receives a second input via the GUI that responds to the second prompt and returns a decision based on the first and second inputs received through the GUI.

In some embodiments, a non-transitory computer-readable storage medium contains instructions that, when executed by a processor, enable the method described. These instructions guide the processor to access the decisioning tool's configuration, determine prompts, generate and modify the GUI based on user inputs, and return a decision accordingly.

In additional embodiments, an apparatus includes a processor and a memory that stores instructions for executing the method when run by the processor. The sequence involves accessing the tool's configuration, determining prompts based on configuration and inputs, generating and modifying the GUI, and returning decisions based on inputs received via the GUI.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates a logic flow 700 in accordance with one embodiment.

FIG. 8 illustrates a computing system 800 in accordance with one embodiment.

### DETAILED DESCRIPTION

Embodiments disclosed herein provide techniques for decisioning tools that implement decisioning logic (e.g., one or more decision trees) to guide users through any number and type of decisioning workflows. For example, the decisioning tools may be used in determining dispute rights for transactions, class enrollments, and training assessments. More generally, the decisioning tool may support any number and types of decisioning logic based on a predetermined configuration that guides the tool. Therefore, a decisioning tool for determinizing dispute rights for transactions is used as a reference example herein, and embodiments are not limited in these contexts.

The configuration of the decisioning tool may specify different paths of a decision tree, where each path generally guides users through a series of questions to determine the appropriate outcome. For example, the decisioning too may allow users to determine whether they have dispute rights for certain transactions. Based on the configuration, embodiments disclosed herein allow users to simply click on pre-populated answers (and/or enter values manually) to determine an appropriate dispute code (and/or determine dispute rights are not available) for a transaction.

In some embodiments, the configuration supports a dynamic web application hosted on any suitable platform. Doing so allows for a more robust and interactive user experience. The web-based tool may be designed to be live and accessible while ensuring that there is no proprietary information within the system itself.

In some embodiments, the configuration supports a decision tree interface. This interface guides users through a series of questions to determine the appropriate dispute code. The decision tree is dynamically built based on information from the configuration file. This approach allows for easy updates and flexibility, as the logic and flow can be modified by simply updating the configuration. Similarly, different decisioning trees, logic, and/or flows may be created by defining configuration files for these tasks.

In some embodiments, the decisioning tool includes comprehensive reporting capabilities. For example, in some embodiments, the decisioning tool outputs data to a standardized dataset, which may be used for compliance and analytics. In some embodiments, the output data may be parsed for various insights, such as identifying compliance issues, analyzing teammate effectiveness, and tracking the types of disputes (e.g., fraud vs. non-fraud).

In some embodiments, to enhance usability, the tool includes built-in help sections (e.g., text instructions, video tutorials, image tutorials, etc.). These resources may provide users with guidance on how to navigate the tool and understand the decision-making process. The tool also incorporates ADA-compliant features, such as alt text for images and captions for videos, ensuring accessibility for all users.

In some embodiments, the tool's modular and flexible structure allows it to be adapted for other uses beyond dispute resolution. For example, it can be used for class enrollment and training assessments. The tool can generate logic flows for various scenarios and write data back to the output store, making the tool a versatile solution for different decision-based processes within the organization.

In some embodiments, integration with a centralized data source for configuration and/or output data may ensure that there is a single source of truth for updates and access controls. This integration may facilitate the reporting and analytical capabilities of the tool, as data can be easily accessed and managed through the centralized data source.

More generally, embodiments disclosed herein may improve efficiency and accuracy in handling disputes and other decision-based processes. In some embodiments, the tool may be used as a training tool to help teammates learn the correct procedures for handling disputes. The reporting capabilities also allow managers to monitor teammate effectiveness and identify areas for improvement.

Advantageously, embodiments disclosed herein provide a dynamic, user-friendly, and flexible solution for determining dispute rights and other decision-based processes within an organization. By providing an intuitive decision tree interface that guides users through a series of questions to determine an appropriate outcome, embodiments disclosed herein reduce the complexity and time required for teammates to make decisions, enhancing overall efficiency. By integrating with a centralized data source, the tool centralizes all data, ensuring a single source of truth, which eliminates the need for multiple versions of configuration files and simplifies data management and updates. This is in contrast to conventional systems, which often struggle with data fragmentation and version control issues. The output data in the centralized data source may advantageously provide comprehensive reporting and analytics. For example, the tool may be used to track compliance, analyze teammate effectiveness, and identify areas for improvement. Conventional systems may lack such integrated reporting capabilities, making it harder to derive actionable insights. Furthermore, the modular and flexible structure of embodiments disclosed herein allow for the adaptation to any type of use case. In contrast, conventional systems are rigid and limited in scope. Further still, by dynamically building the decision tree interfaces based on information from the configuration, embodiments disclosed herein provide automation that allows for easy updates and ensures that the logic flow is always current and accurate. Advantageously, embodiments disclosed herein may easily accommodate additional features and use cases, such as supporting different file formats and integrating with other databases, which further increases flexibility and applicability. In contrast, conventional systems often struggle with scalability and adaptability. Embodiments are not limited in these contexts.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

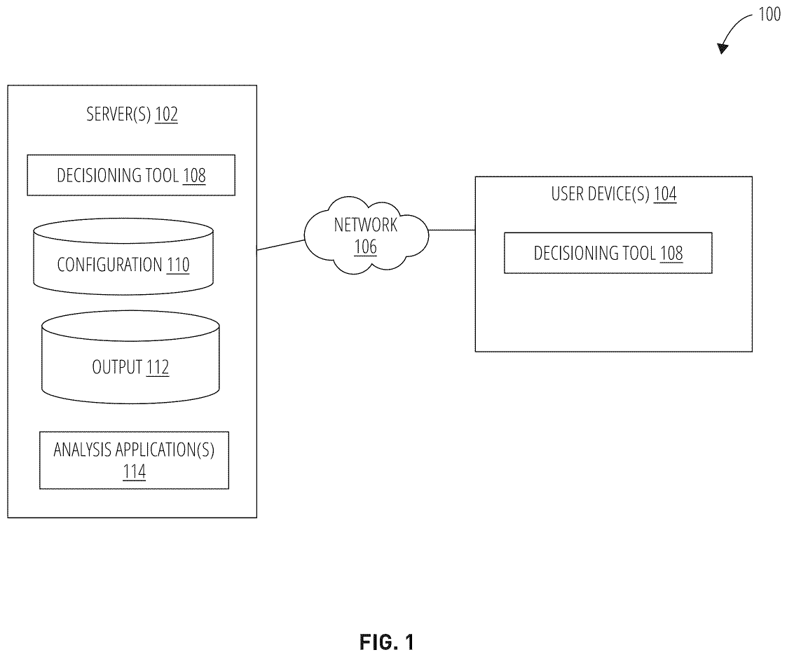

FIG. 1 illustrates a system 100 according to one embodiment. As shown, the system 100 includes one or more servers 102 and one or more user devices 104 communicably coupled via one or more networks 106. The servers 102 and user devices 104 are representative of any type of physical and/or virtualized computing system. The servers 102 and user devices 104 each include at least one processor for executing instructions and at least one memory for storing instructions, each not pictured for the sake of clarity.

As shown, the servers 102 include a decisioning tool 108, one or more data stores of configuration 110 for the decisioning tool 108, one or more data stores for output 112 of the decisioning tool 108, and one or more analysis applications 114 to analyze the output 112. Similarly, user devices 104 include an instance of the decisioning tool 108. In some embodiments, the decisioning tool 108 may be implemented as one or more web pages that may be accessed via a web browser. Although depicted as part of the server 102, the decisioning tool 108, configuration 110, output 112, and/or analysis applications 114 may be implemented on different systems.

The decisioning tool 108 may be implemented as any type of executable code, such as applications, web pages, processes, scripts, services, microservices, artificial intelligence (AI) agents, and the like. In some embodiments, the decisioning tool 108 is at least partially implemented in JavaScript. The decisioning tool 108 is generally configured to provide a decision tree interface that guides users through a series of questions (also referred to as prompts) to determine an appropriate outcome. For example, in the disputes rights context, the decisioning tool 108 may guide users through the different prompts to determine an appropriate dispute code for a transaction (or determine the transaction is not eligible for a dispute). However, the decisioning tool 108 may be used in any context, and the use of dispute code determination is not limiting of the disclosure.

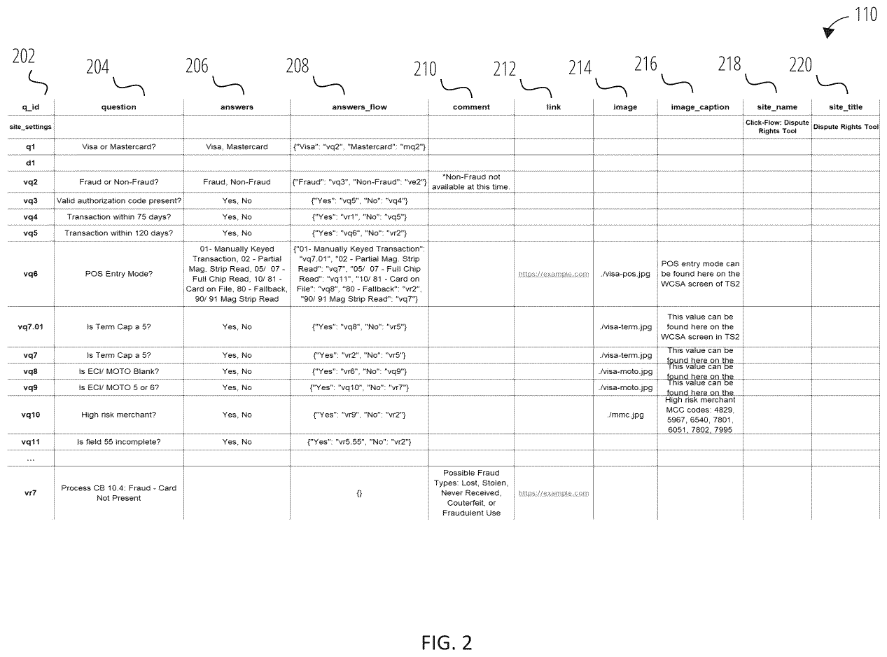

The configuration 110 generally includes logic for one or more decision trees to be implemented via the decisioning tool 108. Although depicted as a database, the configuration 110 may be implemented in any format. For example, the configuration 110 may be a spreadsheet, JSON file, XML file, a comma separated value (CSV) file, and the like. An example configuration 110 is depicted in FIG. 2, which is described in greater detail below.

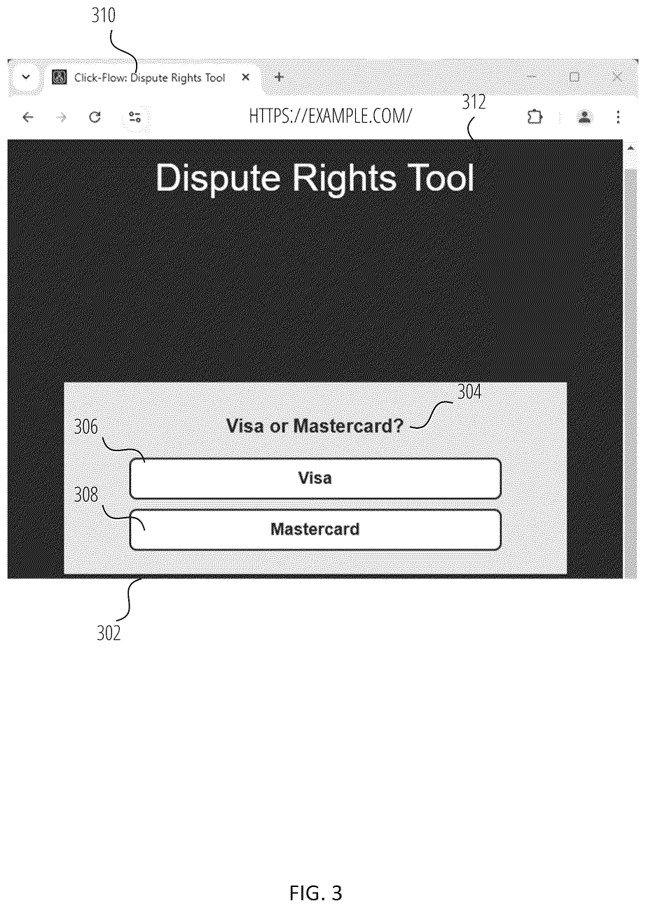

Generally, the configuration 110 may define the logic, data, and/or flows to guide a user through one or more decision trees via one or more adaptive graphical user interfaces (GUIs). For example, the configuration 110 may include questions, supported answers, a flow of next steps of the decision tree, links, images, video, audio, captions, and/or titles that can be included in one or more GUIs of the decisioning tool 108. Example GUIs are depicted in FIGS. 3-5, which are described in greater detail below.

For example, the configuration 110 may specify a plurality of prompts, where each prompt may correspond to a node of a decision tree. The configuration 110 may further define different flows through the nodes of the decision tree, with leaf nodes being associated with respective outcomes of a plurality of outcomes. For example, different leaf nodes in the decision tree may define different dispute codes for transactions and/or indicate that dispute rights are not available.

The output of the decisioning tool 108 may be stored in the output 112. Doing so allows the aggregated data in the output 112 to be collectively analyzed by the decisioning tool 108 and/or the analysis applications 114. For example, the analysis applications 114 may analyze the number of disputed transactions when using the decisioning tool 108, the determine the respective frequencies a plurality of dispute codes are reached when using the decisioning tool 108, user statistics (e.g., how often does the user of the decisioning tool 108 reach a correct outcome, code, etc.). Embodiments are not limited in these contexts, as the analysis applications 114 may implement any algorithm to analyze the output 112. In some embodiments, the output of the analysis applications 114 may be stored in the output 112. Embodiments are not limited in these contexts.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 106 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 104 may include automatic teller machines (ATMs) utilized by the system 100 in serving users. In another example, the servers 102 represent payment clearinghouse or payment rail systems for processing payment transactions, and in another example, the servers 102 such as merchant systems or banking systems configured to interact with the user devices 104 during transactions and also configured to interact with the enterprise system 100 in back-end transactions clearing processes.

The user devices 104 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 104) to serve users in their interactions to communicate and take action. In such embodiments, the user devices 104 can be, as non-limiting examples, computing devices, kiosks, terminals, smart devices such as phones, and devices and tools at customer service counters and windows at POS locations.

FIG. 2 is a schematic illustrating a portion of a configuration 110 for the decisioning tool 108, according to one embodiment. As shown, the configuration 110 includes an identifier (ID) column 202, a question column 204, an answers column 206, a flow column 208, a comment column 210, a link column 212, an image column 214, an image caption column 216, a site name column 218, and a site title column 220. Although a limited number of rows are depicted in FIG. 2, the configuration 110 may include more or fewer rows.

The ID column 202 may include unique identifiers for each row of data in the configuration 110. Generally, any alphanumeric identifier may be used in the ID column 202. The question column 204 may include at least a portion of text for a question (or prompt) associated with the corresponding row. The answers column 206 may include one or more predefined answers to the question in the question column 204. The flow column 208 generally includes at least one unique ID from the ID column 202. In some embodiments, each answer in the answers column 206 is associated with a unique ID from the ID column 202 in flow column 208. For example, in the flow column 208 of row q1, an answer of “Visa” is associated with the unique identifier of “vq2”, while an answer of “Mastercard” is associated with the unique identifier of “mq2”. Therefore, the next question presented to the user may differ based on the answer to the current question (e.g., question vq2 is presented if the user answers “Visa” while question “mq2” (not pictured in FIG. 2 due to space limitations) is presented if the user answers “Mastercard”). Embodiments are not limited in these contexts.

The comment column 210 may include one or more comments that may be displayed to the user in one or more GUIs. The link column 212 may include a link (e.g., a uniform resource identifier (URI) and/or uniform resource locator (URL)) to a resource that may be displayed in one or more GUIs. The image column 214 may include a link to an image that may be displayed in one or more GUIs. The image caption column 216 may include a caption that is associated with the image in the image column 214, where the caption may be displayed with the image in one or more GUIs. The comments in the comment column 210, the links in the link column 212, the images in the image column 214, and/or the captions in the image caption column 216 may be resources that can be displayed in a GUI by the decisioning tool 108, e.g., to assist and/or guide users. For example, the link column 212 may include a link to manuals, guides, instructions, etc. The resources may therefore be of any format, such as text, images, videos, audio files, web sites, etc.

The site name column 218 may include a name of the site, while the site title column 220 may include a title of the site, e.g., in embodiments where the decisioning tool 108 is implemented as a web-based tool that is accessed via a web browser.

Generally, the decisioning tool 108 may generate GUIs based on the configuration 110 to step through the decision trees to reach an outcome. For example, when initiated, the decisioning tool 108 may access row q1, present the question in question column 204, provide GUI elements to reflect the answers in answers columns 206, etc. When the user selects an answer from answers column 206, the decisioning tool 108 identifies the next question associated with the selected answer from the flow column 208, and so on.

FIG. 3 illustrates a graphical user interface 302 generated by the decisioning tool 108, according to one embodiment. As stated, the graphical user interface 302 may be one of a plurality of GUIs generated by the decisioning tool 108 based on the configuration 110. The graphical user interface 302 may be implemented by the decisioning tool 108 via a web page, an application page, etc. In the example depicted in FIG. 3, the decisioning tool 108 generates the graphical user interface 302 based on the first row of data in the configuration 110 depicted in FIG. 2.

More specifically, the graphical user interface 302 includes an indication of a question 304, which is based on the text in question column 204 in the first row in the configuration 110 of FIG. 2. Similarly, the graphical user interface 302 includes a site name 310 and site title 312, based on the site name column 218 and site title column 220 in the configuration 110 of FIG. 2. Furthermore, the graphical user interface 302 includes a selectable element 306 and a selectable element 308 corresponding to answers “Visa” and “Mastercard” respectively, from the answers column 206 in the configuration 110 of FIG. 2. Generally, the user may select one of the selectable elements 306, 308, to proceed to the next question in the decisioning tool 108, where the next question is defined by the flow column 208 in the configuration 110 of FIG. 2. When a selection is received, the decisioning tool 108 may store an indication of the response in memory.

Although depicted as selectable elements 306-308 (e.g., buttons), the answers in the answers column 206 may be implemented via any interface, such as a dropdown list, radio buttons, etc. Embodiments are not limited in these contexts.

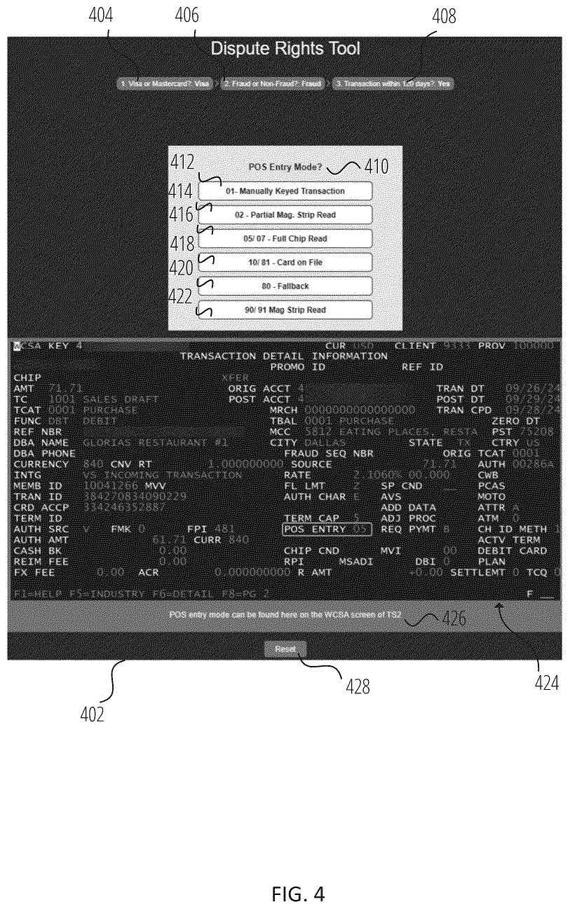

FIG. 4 illustrates a graphical user interface 402 generated by the decisioning tool 108, according to one embodiment. In the example depicted in FIG. 4, the user has answered three previous questions. Indications of the previously answered questions are depicted as navigation elements 404-408 that reflect the previous question and the corresponding answer provided by the user. Generally, selection of one of the navigation elements 404-408 may allow the user to return to the corresponding question. For example, selecting navigation element 404 may cause the decisioning tool 108 to display graphical user interface 302 to the user. If the user selects a different response when returning to a previous question, the decisioning tool 108 may overwrite, update, or otherwise store the different response in memory (and ultimately in the output 112).

As shown, graphical user interface 402 includes an indication of a question 410, which may be based on the previous response submitted by the user. For example, as depicted in navigation element 408, the user answered “yes” to the question “Transaction within 120 days?” The question 410 may therefore be specified in the configuration 110 of FIG. 2 in the flow column 208 for row vq5, e.g., where an answer of yes is associated with vq6 in flow column 208. Therefore, the question 410 is based on the question 304 in the row for vq6. Similarly, a plurality of selectable elements 412-422 are generated by the decisioning tool 108 based on the answers column 206 of the configuration 110 in FIG. 2. A user may select one of the selectable elements 412-422 to proceed to the next question.

To assist users, a detailed view 424 may be included in the graphical user interface 402. In some embodiments, the detailed view 424 is displayed based on the user selecting a selectable element (e.g., a help icon). The detailed view 424 depicted in FIG. 4 may depict actual transaction data for the transaction being analyzed. The detailed view 424 may be based on the image column 214 and/or link column 212. However, as stated, any text, images, graphics, video, audio, and/or links may be presented by the decisioning tool 108. Furthermore, the graphical user interface 402 includes a caption 426 which is based on the image caption column 216 in the configuration 110. A reset element 428 may allow the user to return to the first question in the configuration 110.

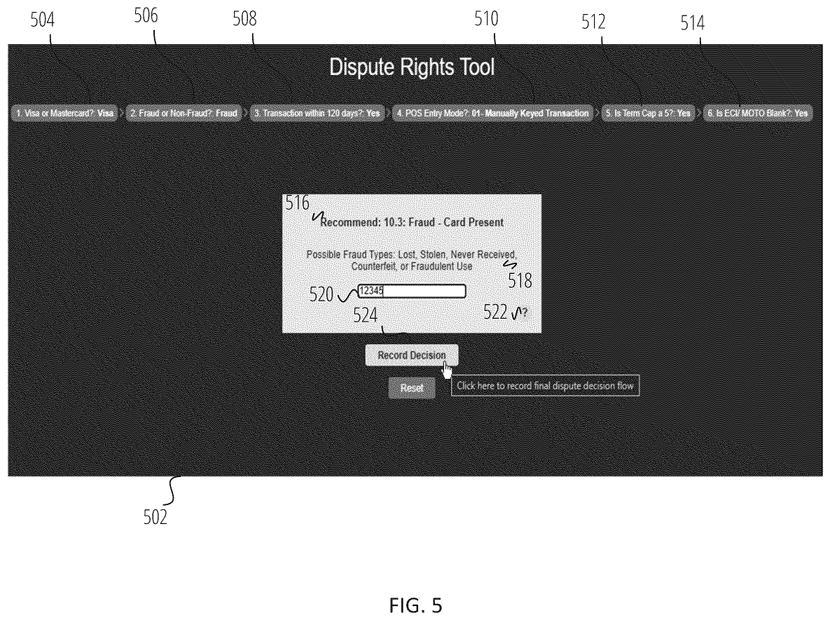

FIG. 5 illustrates a graphical user interface 502 generated by the decisioning tool 108, according to one embodiment. In the example depicted in FIG. 5, the user has answered previous questions sufficient to reach a decision, e.g., a leaf node of the decision tree. Indications of the previously answered questions are depicted as navigation elements 504-514.

As shown, an indication of the decision 516 is outputted by the decisioning tool 108 in the graphical user interface 502. The decision 516 generally indicates a recommended dispute code for a transaction, e.g., code 10.3, which may be associated with card present instances of fraud. In some embodiments, the text of the decision 516 is specified as a question in question column 204 in the configuration 110 (e.g., row vr7 depicted in FIG. 2). The flow column 208 for the previous question may specify the row of the question for the decision in the configuration 110. The graphical user interface 502 further includes comments 518 associated with the row in the configuration 110.

A user may specify an identifier for the submission in input field 520. By selecting a submission element 524, the user may submit the data collected for each answer in the output 112. By selecting help element 522, the user may view additional information, e.g., a link in the link column 212, an image in the image column 214, etc. For example, selection of the help element 522 may display the detailed view 424. Embodiments are not limited in these contexts.

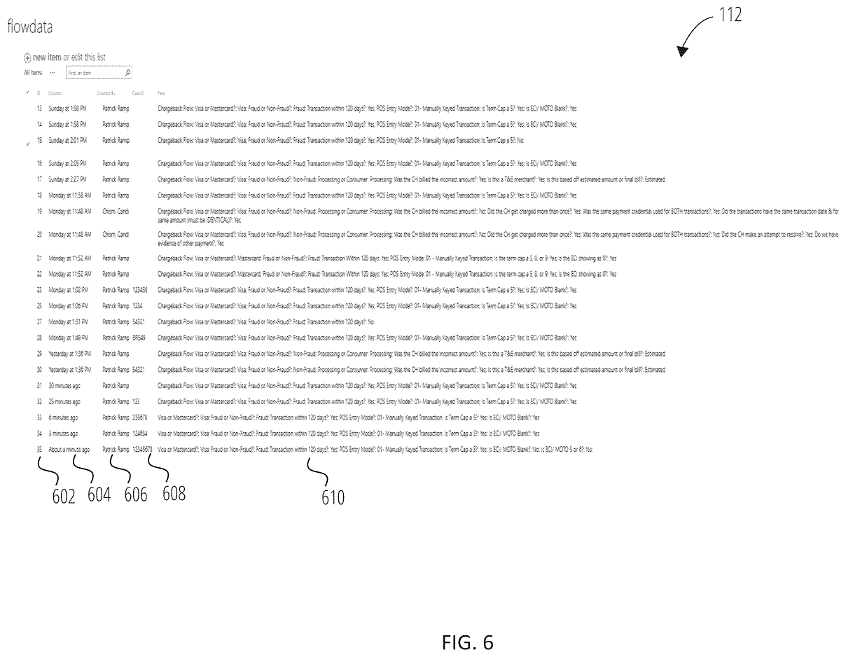

FIG. 6 illustrates an example portion of the output 112, according to one embodiment. As shown, the output includes an ID column 602, a date column 604, a user column 606, a submission ID column 608, and a flow column 610. The ID column 602 may uniquely identify each row of the output 112. The date column 604 may correspond to a date and time the row was created. The user column 606 may identify a user who logged in and used the decisioning tool 108 to complete a decision flow. The submission ID column 608 may include the submission identifier provided by the user via the input field 520. The flow column 610 includes the questions and answers provided by each user. In some embodiments, the flow column 610 may include the final output decision provided by the decisioning tool 108. Embodiments are not limited in these contexts.

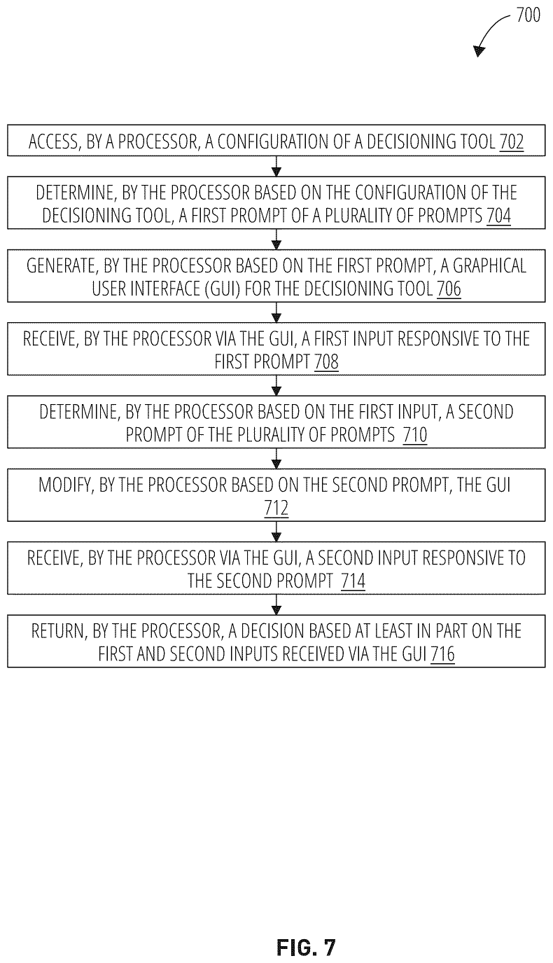

FIG. 7 illustrates an example logic flow 700 for an interactive decisioning tool with adaptive graphical user interfaces. Although the example logic flow 700 depicts a particular sequence of operations, the sequence may be altered without departing from the scope of the present disclosure. For example, some of the operations depicted may be performed in parallel or in a different sequence that does not materially affect the function of the logic flow 700. In other examples, different components of an example device or system that implements the logic flow 700 may perform functions at substantially the same time or in a specific sequence.

According to some examples, the logic flow 700 includes accessing, by a processor, a configuration of a decisioning tool at block 702. For example, the decisioning tool 108 illustrated in FIG. 1 may access a configuration 110.

According to some examples, the logic flow 700 includes determining, by the processor based on the configuration of the decisioning tool, a first prompt of a plurality of prompts at block 704. For example, the decisioning tool 108 illustrated in FIG. 1 may determine, based on the configuration 110, a first prompt of a plurality of prompts (e.g., a first question of a plurality of questions specified in the configuration 110).

According to some examples, the logic flow 700 includes generating, by the processor based on the first prompt, a graphical user interface (GUI) for the decisioning tool at block 706. For example, the decisioning tool 108 may generate, based on the configuration 110 for the first prompt, a graphical user interface (GUI) such as graphical user interface 302, graphical user interface 402, and/or graphical user interface 502.

According to some examples, the logic flow 700 includes receiving, by the processor via the GUI, a first input responsive to the first prompt at block 708. For example, the decisioning tool 108 may receive, via the GUI, a first input responsive to the first prompt. For example, the user may specify Visa as the card type in GUI graphical user interface 302.

According to some examples, the logic flow 700 includes determining, by the processor based on the first input, a second prompt of the plurality of prompts at block 710. For example, the decisioning tool 108 may determine, based on the first input, a second prompt of the plurality of prompts. For example, the answer of “Visa” received at block 708 may be associated with another question in the configuration 110. Therefore, the decisioning tool 108 may access the flow column 208 to identify the next question associated with “Visa” in the configuration 110.

According to some examples, the logic flow 700 includes modifying, by the processor based on the second prompt, the GUI at block 712. For example, the decisioning tool 108 illustrated in FIG. 1 may modify, based on the second prompt, the GUI. For example, the decisioning tool 108 may present a graphical user interface to display the question and any associated data in the configuration 110.

According to some examples, the logic flow 700 includes receiving, by the processor via the GUI, a second input responsive to the second prompt at block 714. For example, the decisioning tool 108 may receive, via the GUI generated at block 712, a second input responsive to the second prompt.

According to some examples, the logic flow 700 includes returning, by the processor, a decision based at least in part on the first and second inputs received via the GUI at block 716. For example, the decisioning tool 108 may return a decision based at least in part on the first and second inputs received via the GUI. The decision may be based on the input received at block 714, e.g., the flow column 208 being associated with a decision node of the decision tree implemented by the configuration 110. The decision and other data collected by the decisioning tool 108 may then be stored in the output 112. Embodiments are not limited in these contexts.

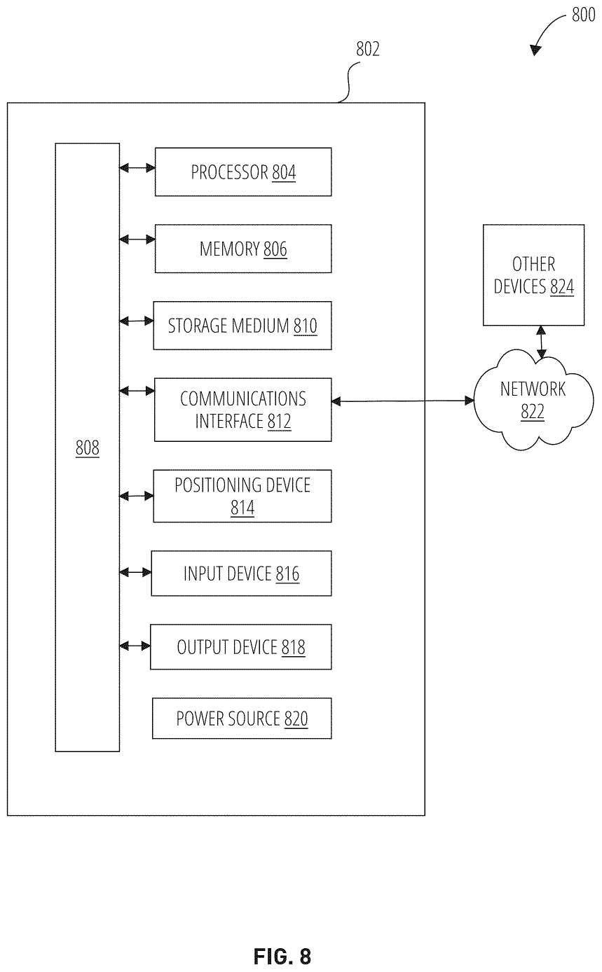

FIG. 8 illustrates an example computing system 800 suitable for implementing various embodiments as described herein. As shown, the computing system 800 comprises a computer 802, which is representative of any type of physical and/or virtualized computing device. Examples of the computer 802 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 802 is representative of some or all of the components of the servers 102 and/or user devices 104. More generally, the computing system 800 is configured to implement all systems, methods, apparatuses, media, and embodiments disclosed herein.

As shown, the computer 802 includes one or more processors 804, one or more memories 806, one or more non-transitory storage media 810, one or more communications interfaces 812, one or more positioning devices 814, one or more input devices 816, and one or more output devices 818 communicably coupled via an interconnect 808. A power source 820, such as a power supply, battery, or any type of power source may provide power to the computer 802.

The processor 804 is representative of any type of processing circuit. For example, the processor 804 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 806 is representative of any computer readable medium to store data, code, or other information. The memory 806 may include volatile memory, such as volatile Random Access Memory (RAM) including a cache area for the temporary storage of data. The memory 806 may also include non-volatile memory, which can be embedded and/or may be removable. The non-volatile memory can additionally or alternatively include an electrically erasable programmable read-only memory (EEPROM), flash memory or the like. The storage medium 810 is representative of any type of computer readable medium to store data, code, or other information. Examples of storage media 810 include solid state drives, hard drives, Redundant Array of Independent Disks (RAID) drives, memory pools, universal serial bus (USB) storage devices, and the like. In some embodiments, the memory 806 and/or storage medium 810 may store the decisioning tool 108, configuration 110, output 112, and/or analysis applications 114.

The memory 806 and storage medium 810 can store any number and type of computer-executable instructions executed by the processor 804 to implement the functions of the computer 802 described herein. For example, the memory 806 may include such applications as a web browser application and/or a mobile P2P payment system client application. These applications also typically provide a graphical user interface (GUI) on a display that allows the user to communicate with the computer 802, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 806 and/or storage medium 810 may be used to store data such as cached data, files for user accounts, user profiles, account balances, transaction histories, files downloaded or received from other devices, and any other data items.

The interconnect 808 is representative of any type of circuitry to connect the components of the computer 802. For example, the interconnect 808 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 804 to the memory 806, individual electrical connections among the components, and electrical conductive traces on a motherboard common to some or all of the above-described components of the computer 802. As discussed herein, the interconnect 808 may operatively couple various components with one another, or in other words, electrically connects those components, either directly or indirectly-by way of intermediate component(s) -with one another.

The one or more input devices 816 are representative of any type of input device for receiving input, such as a keypad, keyboard, touchscreen, touchpad, microphone, camera, fingerprint sensor, mouse, joystick, other pointer device, button, soft key, and the like. The one or more output devices 818 are representative of any type of device for outputting information, such as a monitor, speaker, haptic feedback module, printer, and the like.

The computer 802 may use the communications interface 812 to communicate with one or more other devices 824 via a network 822. The communications interface 812 allows the computer 802 to communicate with and conduct transactions with other devices and systems, such as the other devices 824. The communications interface 812 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 812, which can be or include a radio-frequency transceiver, a Bluetooth device, Wi-Fi device, a Near-Field Communication (NFC) device, and other wireless transceivers. In addition, a positioning device 814 such as a Global Positioning System (GPS) device may be included for navigation and location-related data exchanges, ingoing and/or outgoing. Wi-Fi networks use radio technologies such as the Institute of Electrical and Electronics Engineers (IEEE) 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also and/or alternatively be conducted via wired connections using the communications interface 812, e.g., using USB, Ethernet, and other physically connected modes of data transfer. The network 822 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 802 is configured to use the communications interface 812 as, for example, a network interface to communicate with one or more other devices on a network such as network 822. In this regard, the computer 802 utilizes the wireless communications interface 812 as an antenna operatively coupled to a transmitter and a receiver (together a “transceiver”) included with the communications interface 812. The communications interface 812 is configured to provide signals to and receive signals from the transmitter and receiver, respectively. The signals may include signaling information in accordance with the air interface standard of the applicable cellular system of a wireless telephone network. In this regard, the computer 802 may be configured to operate with one or more air interface standards, communication protocols, modulation types, and access types. By way of illustration, the computer 802 may be configured to operate in accordance with any of a number of first, second, third, fourth, fifth-generation communication protocols and/or the like. For example, the as a smartphone, the computer 802 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 802 may also be configured to operate in accordance with non-cellular communication mechanisms, such as via a wireless local area network (WLAN) or other communication/data networks.

The communications interface 812 may also include a payment network interface. The payment network interface may include software, such as encryption software, and hardware, such as a modem, for communicating information to and/or from one or more devices on a network. For example, the computer 802 may be configured so that it can be used as a credit or debit card by, for example, wirelessly communicating account numbers or other authentication information to a terminal of the network. Such communication could be performed via transmission over a wireless communication protocol such as the NFC protocol.

The computer 802 may be under the control of any suitable operating system (not pictured). Example operating systems include, but are not limited to, Linux® operating systems, UNIX®, Windows® operating systems, macOS®, iOS®, Android® and any other type of operating system.

The computer 802 as illustrated diagrammatically represents at least one example of a possible implementation, where alternatives, additions, and modifications are possible for performing some or all of the described methods, operations, and functions. Although shown separately, in some embodiments, two or more computers 802, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described to explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
accessing, by a processor, a configuration of a decisioning tool;
determining, by the processor based on the configuration of the decisioning tool, a first prompt of a plurality of prompts;
generating, by the processor based on the first prompt, a graphical user interface (GUI) for the decisioning tool;
receiving, by the processor via the GUI, a first input responsive to the first prompt;
determining, by the processor based on the first input, a second prompt of the plurality of prompts;
modifying, by the processor based on the second prompt, the GUI;
receiving, by the processor via the GUI, a second input responsive to the second prompt;
returning, by the processor, a decision based at least in part on the first and second inputs received via the GUI.

2. The method of claim 1, wherein the configuration of the decisioning tool comprises a decision tree.

3. The method of claim 1, further comprising:
receiving, by the processor via the GUI, input selecting an indication of the first prompt; and
modifying, by the processor, the GUI based on the first prompt.

4. The method of claim 3, further comprising:
receiving, by the processor via the GUI modified based on the first prompt, a third input responsive to the first prompt; and
determining, by the processor based on the third input, a third prompt of the plurality of prompts.

5. The method of claim 4, wherein the first input is different than the third input, wherein the first prompt is different than the third prompt.

6. The method of claim 5, wherein the processor overwrites the first input with the third input.

7. The method of claim 1, wherein the GUI is implemented in one or more web pages.

8. The method of claim 1, further comprising prior to returning the decision:
determining, by the processor, the decision based at least in part on the first and second inputs received via the GUI.

9. The method of claim 1, further comprising prior to returning the decision:
determining, by the processor based on the second input and the configuration, to generate the decision.

10. The method of claim 1, further comprising:
storing, by the processor, the first input, the second input, and the decision in a data store.

11. The method of claim 10, wherein the data store comprises a plurality of inputs received via the GUI from a plurality of users, wherein the plurality of inputs include the first input and the second input.

12. The method of claim 11, wherein the data store further comprises a plurality of decisions generated by the processor including the decision.

13. The method of claim 12, further comprising:
analyzing, by the processor the data store.

14. The method of claim 1, wherein generating the GUI comprises:
determining, by the processor based on the configuration, a plurality of predetermined responses to the first prompt.

15. The method of claim 14, wherein generating the GUI comprises:
generating, by the processor, a dropdown list comprising the plurality of predetermined responses.

16. The method of claim 1, wherein generating the GUI comprises:
determining, by the processor based on the configuration, a resource associated with the first prompt; and
displaying, by the processor, an indication of the resource in the GUI.

17. The method of claim 16, wherein the resource comprises one or more of: (i) text, (ii) an image, (iii) a link, or (iv) a video.

18. The method of claim 17, wherein the resource comprises the link, the method further comprising:
receiving, by the processor, selection of the link;
accessing, by the processor the resource at the link; and
displaying, by the processor, the resource.

19. A non-transitory computer-readable storage medium, the computer-readable storage medium including instructions that when executed by a processor, cause the processor to:
access a configuration of a decisioning tool;
determine, based on the configuration of the decisioning tool, a first prompt of a plurality of prompts;
generate, based on the first prompt, a graphical user interface (GUI) for the decisioning tool;
receive, via the GUI, a first input responsive to the first prompt;
determine, based on the first input, a second prompt of the plurality of prompts;
modify, based on the second prompt, the GUI;
receive, via the GUI, a second input responsive to the second prompt;
return a decision based at least in part on the first and second inputs received via the GUI.

20. An apparatus, comprising:
a processor; and
a memory storing instructions that, when executed by the processor, cause the processor to:
access a configuration of a decisioning tool;
determine, based on the configuration of the decisioning tool, a first prompt of a plurality of prompts;
generate, based on the first prompt, a graphical user interface (GUI) for the decisioning tool;
receive, via the GUI, a first input responsive to the first prompt;
determine, based on the first input, a second prompt of the plurality of prompts;
modify, based on the second prompt, the GUI;
receive, via the GUI, a second input responsive to the second prompt;
return a decision based at least in part on the first and second inputs received via the GUI.
